(19) United States
(12) Patent Application Publication
(10) Pub. No.: US 2018/0084409 A1
(43) Pub. Date: Mar. 22, 2018

(54) Virtual Device with Internet Protocol Security Tunnel

(71) Applicant: Ruckus Wireless, Inc., Sunnyvale, CA (US)

(72) Inventor: Mitch Rappard, Lees Summit, MO (US)

(73) Assignee: Ruckus Wireless, Inc., Sunnyvale, CA (US)

(21) Appl. No.: 15/558,529

(22) PCT Filed: Mar. 30, 2016
(86) PCT No.: PCT/US16/25064

§ 371 Date: Sep. 14, 2017

Related U.S. Application Data
(60) Provisional application No. 62/141,157, filed on Mar. 31, 2015.

(51) Int. Cl. H04W 12/02; H04W 12/06; H04L 29/06; H04W 76/02

(52) U.S. Cl. CPC H04W 12/02; H04W 12/06; H04L 63/029; H04W 84/12; H04W 76/022; H04L 2209/80; H04L 63/164

(57) ABSTRACT

An electronic device that establishes one or more Internet Protocol Security (IPSec) tunnels with an Evolved Packet Core (EPC) for another electronic device is described. In particular, the electronic device may receive, from the other electronic device, Extensible Authentication Protocol (EAP) information using a wireless local area network (WLAN) communication protocol, where the EAP information includes credentials used by the EPC to authenticate the other electronic device. Then, the electronic device may establish, with the EPC, one or more IPSec tunnels on behalf of the other electronic device using a wired communication protocol, where the one or more IPSec tunnels originate and terminate at the electronic device. Next, the electronic device may communicate encrypted information with the other electronic device using the WLAN communication protocol, where the encrypted information is encrypted using a different encryption protocol than IPSec.

### BACKGROUND

### Field

The described embodiments relate to techniques for communicating information among electronic devices. In particular, the described embodiments relate to techniques for establishing an Internet Protocol Security tunnel on behalf of another electronic device.

### Related Art

Many electronic devices are capable of wirelessly communicating with other electronic devices. For example, these electronic devices can include a networking subsystem that implements a network interface, such as a wireless local area network (WLAN), e.g., a wireless network such as one described in an Institute of Electrical and Electronics Engineers (IEEE) 802.11 standard (which is sometimes referred to as Wi-Fi′).

There is increased interest in using a WLAN communication protocol to communicate voice communication (such as telephone calls), which is sometimes referred to as ‘Wi-Fi calling.’ In order to enhance the security of this communication, Wi-Fi calling often uses an Internet Security Protocol (IPSec) tunnel between a portable electronic device and the telephone network infrastructure, such as an Evolved Packet Core (EPC).

However, the communication using WLAN communication protocol is also typically encrypted. This dual encryption is processor intensive and, therefore, may significantly reduce the battery life of the portable electronic device. In addition, the dual encryption can result in fragmentation issues. For example, the encrypted layer 2 packets associated with the WLAN communication protocol can become too large for inclusion in layer 3 packets (such as Ethernet packets). Consequently, the layer 3 packets may need to be disassembled and reassembled using multiple layer 2 packets, which increases the complexity and latency during processing and, thus, can degrade the communication performance.

### SUMMARY

An electronic device that establishes one or more Internet Protocol Security (IPSec) tunnels with an Evolved Packet Core (EPC) for another electronic device is described. The electronic device includes: an antenna; and an interface circuit that, during operation, communicates with the other electronic device using a wireless local area network (WLAN) communication protocol and the EPC via a wired communication protocol. Moreover, during operation, the electronic device receives, from the other electronic device, Extensible Authentication Protocol (EAP) information using the WLAN communication protocol, where the EAP information includes credentials used by the EPC to authenticate the other electronic device. Then, the electronic device establishes, with the EPC, one or more IPSec tunnels on behalf of the other electronic device using the wired communication protocol, where the one or more IPSec tunnels originate and terminate at the electronic device. Next, the electronic device communicates encrypted information with the other electronic device using the WLAN communication protocol, where the encrypted information is encrypted using a different encryption protocol than IPSec.

Note that the WLAN communication protocol may include Wi-Fi. Moreover, the electronic device may include an access point.

Furthermore, the electronic device may include a network function other than an access point. For example, the electronic device may include a router.

Additionally, during operation the electronic device may advertise to the other electronic device a capability to establish the one or more IPSec tunnels.

In some embodiments, prior to receiving the EAP information, the electronic device associates in the context of the WLAN communication protocol with the other electronic device.

Note that the encrypted information may exclude a second encryption technique associated with the one or more IPSec tunnels.

Moreover, when communicating a packet with the EPC via the one or more IPSec tunnels, the electronic device may include an access point name (APN) in the packet for use by the EPC.

Furthermore, the electronic device: may receive, from the electronic device, a set of APNs associated with different types of information; and when communicating a packet having a type of information with the EPC via the one or more IPSec tunnels, the electronic device may select an APN associated with the type of information and may include the APN in the packet for use by the EPC.

Additionally, the encrypted information may include Dynamic Host Configuration Protocol (DHCP) information associated with the EPC.

In some embodiments, the credentials in the EAP information are encrypted.

Moreover, the electronic device may include: a processor; and a memory, coupled to the processor, which stores a program module that, during operation, is executed by the processor. The program module may include instructions for at least some of the operations performed by the electronic device.

Another embodiment provides a computer-program product for use with the electronic device. This computer-program product includes instructions for at least some of the operations performed by the electronic device.

Another embodiment provides a method. This method includes at least some of the operations performed by the electronic device.

This Summary is provided merely for purposes of illustrating some exemplary embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is block diagram illustrating communication among electronic devices in accordance with an embodiment of the present disclosure.

FIG. 2 is a flow diagram illustrating a method for establishing an Internet Protocol Security (IPSec) tunnel with an Evolved Packet Core (EPC) for another electronic device in accordance with an embodiment of the present disclosure.

FIG. 3 is a drawing illustrating communication among the electronic devices of FIG. 1 during the method of FIG. 2 in accordance with an embodiment of the present disclosure.

FIG. 4 is a drawing illustrating communication among the electronic devices of FIG. 1 during the method of FIG. 2 in accordance with an embodiment of the present disclosure.

FIG. 5 is a drawing illustrating communication among the electronic devices of FIG. 1 during the method of FIG. 2 in accordance with an embodiment of the present disclosure.

FIG. 6 is a block diagram illustrating an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

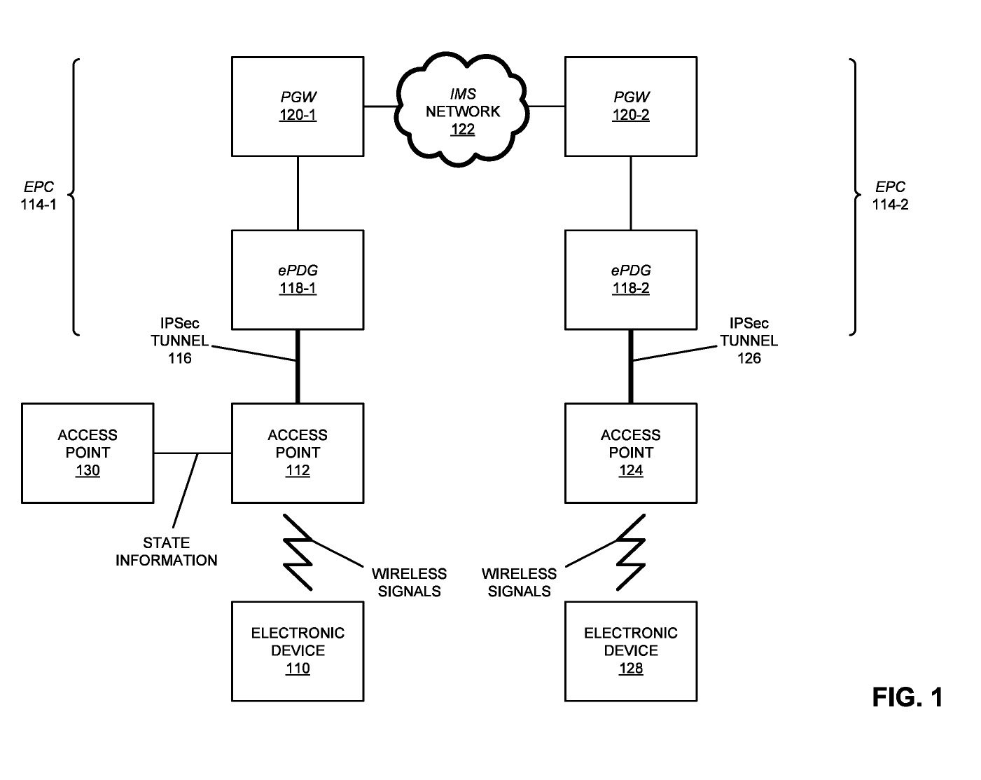

FIG. 1 presents a block diagram illustrating communication among electronic devices. In particular, electronic device 110 (such as a cellular telephone) communicates with access point 112 via a wireless local area network (WLAN) communication protocol (such as Wi-Fi). This communication may be encrypted using an encryption technique, such as Wi-Fi Protected Access II (WPA-2).

Furthermore, access point 112 may communicate with an Evolved Packet Core (EPC) 114-1 via a wired communication protocol. This communication may occur via an Internet Protocol Security (IPSec) tunnel 116 on behalf of electronic device 110 using the wired communication protocol, where the IPSec tunnel originates and terminates at access point 112. Thus, access point 112 may function as a virtual electronic device for electronic device 110 in IPSec tunnel 116. Note that access point 112 may store level-3 or network-layer information in memory on access point 112 in order to encrypt communication on behalf of electronic device 110 with EPC 114-1 using IPSec.

As shown in FIG. 1, EPC 114-1 may include Evolved Packet Data Gateway (ePDG) 118-1 and Packet Date Network Gateway (PGW) 120-1. PGW 120-1 may communicate with Internet Protocol Multimedia Subsystem (IMS) network 122, which communicates with EPC 114-2 that includes PGW 120-2 and ePDG 118-2. Moreover, ePDG 118-2 may communicate with access point 124 using the same or a different wireless communication protocol via IPSec tunnel 126. Then, access point 124 may communicate with electronic device 128 via the same or a different WLAN communication protocol. This communication may also be encrypted using an encryption technique, such as WPA-2.

In this way, electronic devices 110 and 128 may conduct secure communication with each other via EPCs 114. This secure communication may facilitate Wi-Fi calling between electronic devices 110 and 128. (More generally, the secure communication may facilitate communication of a wide variety of information, such as voice, video, data, gaming, etc.) However, by originating and terminating IPSec tunnels 116 and 126 at access points 112 and 124, respectively, this communication technique may avoid double encryption of the wireless communication between electronic device 110 and access point 124 and between electronic device 128 and access point 124. Thus, the communication technique may eliminate the problems that double encryption can cause, such as degraded battery life in electronic devices 110 and 128, and fragmentation issues.

In some embodiments, access points 112 and 124 add an access point name (APN) in the level-3 or the network-layer frames or packets communicated to EPCs 114 (such as in Internet Key Exchange or IKEv2 messages). This APN may be used by EPCs 114 for various functions, including selection of quality-of-service parameters and appropriate PGWs. Furthermore, in some embodiments access points 112 and 124 may establish multiple instances of IPSec tunnels for electronic devices 110 and 128. For example, there may be IPSec tunnels for different types of information, such as voice, data, etc. Then, when access point 112 (or 124) sets up the IPSec tunnels on behalf of electronic device 110 (or 128), electronic device 110 (or 128) may communicate a set of APNs associated with different types of information to electronic device 110 (or 128), which are stored in memory in electronic device 110 (or 128). Using access point 112 as an illustration, when subsequently communicating a packet having a type of information with EPC via one of a set of IPSec tunnels, access point 112 may select an APN associated with the type of information, may include the APN in the packet for use by EPC 114-1, and may route the packet to the selected IPSec tunnel associated with the APN.

Additionally, in some embodiments, if a user of electronic device 110 moves or changes their location, access point 112 hands off communication via the WLAN communication protocol to access point 130. This hand off may include transferring IPSec tunnel 116 (or state information specifying IPSec tunnel 116) so that access point 130 is able to skip some of the operations used to establish a new IPSec tunnel with EPC 114-1. This may involve level-3 or network-layer information being stored in memory on access points 112 and 130. Alternatively or additionally, the level-3 or network-layer information may be stored on a controller or a virtual controller for access points 112 and 130, and the level-3 or network-layer information may be selectively provided to access point 130 when a hand off occurs.

Note that may be multiple IPSec tunnels on an access point (such as access point 124) due to multiple electronic devices. Thus, if there was an electronic device in FIG. 1, it may result in a new IPSec tunnel on access point 124 (for instance), which allows an additional ‘virtual electronic devices’ to be instantiated on access point 124.

While the preceding discussion used Wi-Fi as an illustration, the communication technique may be used with a wide variety of communication protocols. Moreover, while IPSec tunnels 116 and 126 are established by access points 112 and 124 in FIG. 1, in other embodiments IPSec tunnels 116 and 126 originate and terminate on another electronic device having a network function other than an access point. For example, IPSec tunnel 116 (or 126) may originate and terminate on a router. More generally, IPSec tunnel 116 (or 126) may originate and terminate on an electronic device between electronic device 110 (or 126) and EPC 114-1 (or 114-2) that monitors authentication packets or frames. Thus, the router may function as a virtual electronic device for electronic device 110 (or 126) in IPSec tunnel 116 (or 126).

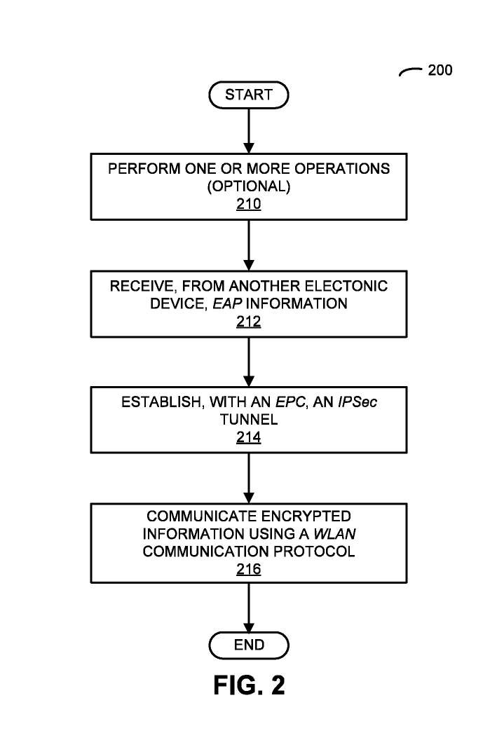

We now describe a method for establishing an IPSec tunnel. Such as IPSec tunnel 116 (or 126) in FIG. 1. FIG. 2 presents embodiments of a flow diagram illustrating method 200 for establishing an IPSec tunnel with an EPC for another electronic device, according to some embodiments, which may be performed by an electronic device (such as an access point or a network function). During operation, the electronic device receives, from the other electronic device, Extensible Authentication Protocol (EAP) information (operation 212) using a wireless local area network (WLAN) communication protocol, where the EAP information includes credentials with the EPC for the other electronic device. Note that the credentials in the EAP information may be encrypted, e.g., using or based on an EAP protocol for authentication and key agreement (EAP-AKA) or an EAP protocol for a subscriber identification module (EAP-SIM). In some embodiments the credentials are associated with a SIM card or a virtual SIM card.

Moreover, the electronic device establishes, with the EPC, the IPSec tunnel (operation 214) on behalf of the other electronic device using a wired communication protocol, where the IPSec tunnel originates and terminates at the electronic device.

Next, the electronic device communicates encrypted information with the other electronic device using the WLAN communication protocol (operation 216), where the encrypted information is encrypted using a different encryption protocol than IPSec. (Note that, in general, the communication between electronic device and the other electronic device is bidirectional.) Because the IPSec tunnel originates and terminates at the electronic device, the encrypted information may exclude a second encryption technique associated with the IPSec tunnel (i.e., the encrypted information may only be encrypted once using the different encryption protocol than IPSec). Note that the encrypted information may include Dynamic Host Configuration Protocol (DHCP) information associated with the EPC, which may include an address of one of the instances of PGW 120 (FIG. 1).

Furthermore, prior to receiving the Extensible Authentication Protocol (EAP) information (operation 212), the electronic device may optionally perform one or more operations (operation 210). For example, the electronic device may advertise to the other electronic device a capability to establish the IPSec tunnel, or the list of APNs it supports. Alternatively or additionally, the electronic device may associate in the context of the WLAN communication protocol with the other electronic device.

In some embodiments of method 200, there may be additional or fewer operations. Moreover, the order of the operations may be changed, and/or two or more operations may be combined into a single operation.

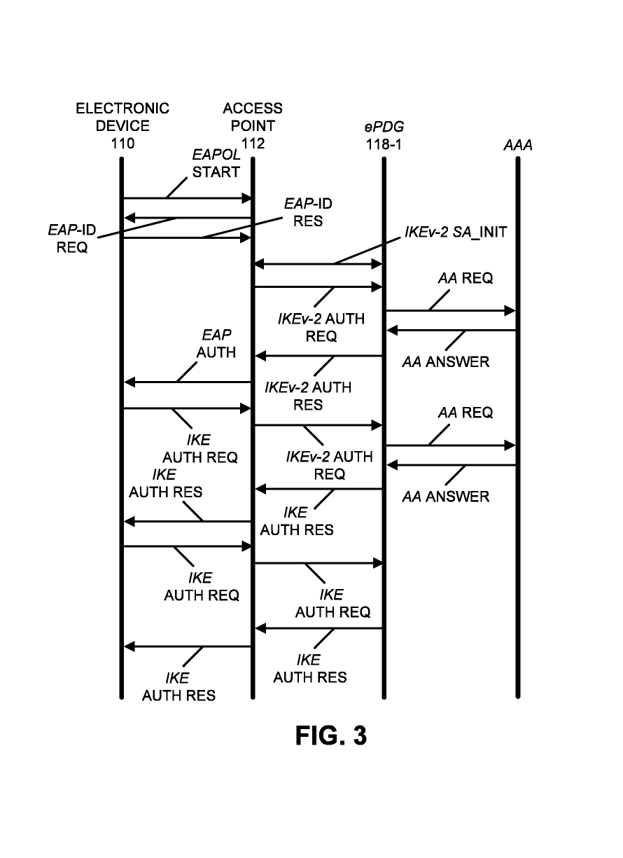

We now further describe exemplary embodiments of the communication technique. FIG. 3 presents a drawing illustrating communication among the electronic devices of FIG. 1 during method 200 in FIG. 2. In particular, FIG. 3 illustrates authentication authorization and accounting (AAA) interaction during the communication technique. Note that the communication technique (including method 300) may be compatible with a technical specification such as the 3^{rd} Generation Partnership Project (3GPP) Technical Specification Group Services and Systems Aspects Architecture Enhancements for Non-SGPP Access (TS 33.402) Release 11. However, access point 112 may appear as user equipment (i.e., a virtual instance of electronic device 110) to ePDG 118-1, but will proxy EAP messages during the EAP exchange.

Note that Wi-Fi association occurs before the EAP messages are exchanged. Moreover, note that access point 112 can find or identify the location of ePDG 118-1 based on the public land mobile network (PLMN) configured on a subscriber identification module (SIM) or a virtual subscriber identification module (vSIM). This information in the credentials of electronic device 110 may specify a fully qualified domain name that maps to the location of ePDG 118-1. Thus, access point 112 may store layer-3 or network-layer information.

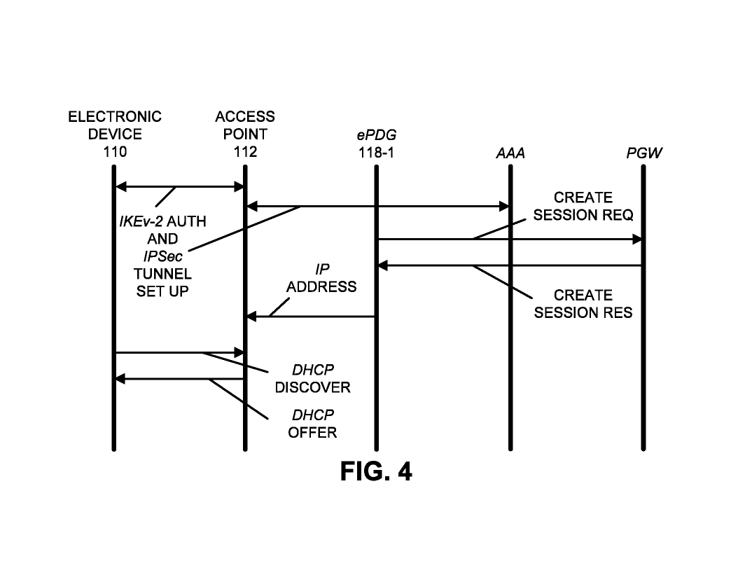

After receiving EAP AUTH (which indicates successful completion of the EAP authorization), electronic device 110 may run an authentication and key agreement technique, verify the authentication, and generate RES and a master session key (MSK). Then, as described further below with reference to FIG. 4, during DHCP discovery access point 112 may receive and store an Internet Protocol (IP) address (and, more generally, DHCP information) for electronic device 110 from ePDG 118-1. Access point 112 may provide the IP address to electronic device 110 via a DHCP offer.

Note that after method 400, IPSec tunnel 116 may established between access point 112 and ePDG 118-1, and the communication between electronic device 110 and access point 112 may be encrypted using a different encryption technique or protocol.

FIG. 4 presents a drawing illustrating communication among the electronic devices of FIG. 1 during method 200 in FIG. 2. In particular, FIG. 4 illustrates how an IP address is assigned by PGW 120-1 (via the create session response) and routed to electronic device 110 by access point 112. For example, the IP address may be provided to electronic device 110 via DHCP by access point 112. When PGW 120-1 assigns the virtual electronic device running on access point 112 the IP address, access point 112 uses the IP address as its DHCP exchange (thus, access point 112 may store the IP address for subsequent use). Thus, access point 112 may simulate a DHCP server. Note that a subnet may need to be configured or derived on access point 112, because PGW 120-1 may not issue a subnet.

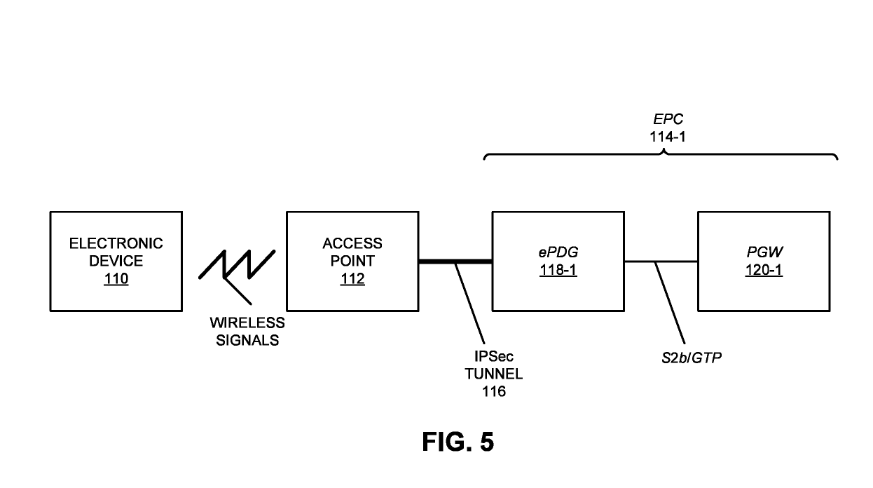

The forwarding of traffic from electronic device 110 to PGW 120-1 is shown in FIG. 5, which presents a drawing illustrating communication among the electronic devices of FIG. 1 during method 200 in FIG. 2. In particular, when enabled, there may be a one-to-one mapping of the WLAN to the virtual electronic device on access point 112. Moreover, all the traffic through the WLAN may traverse IPSec tunnel 116-1 to ePDG 118-1 and then the GPRS Tunneling Protocol (GTP) tunnel to PGW 120-1. Note that ‘traffic selectors’ sent over IKE may indicate the rules about what traffic is sent over IPSec tunnel 116-1, and these rules may be honored by access point 112.

In some embodiments, the communication technique eliminates the need for a trusted wireless access gateway (TWAG). Instead, the network operators can use an ePDG to achieve EPC integration and avoid an overlay ‘trusted non-3GPP network.’ As noted previously, the virtual electronic device running on the access point may result in numerous IPSec tunnels to the ePDG. Moreover, the access point may be more intelligent in the communication technique, e.g., the access point may be APN aware.

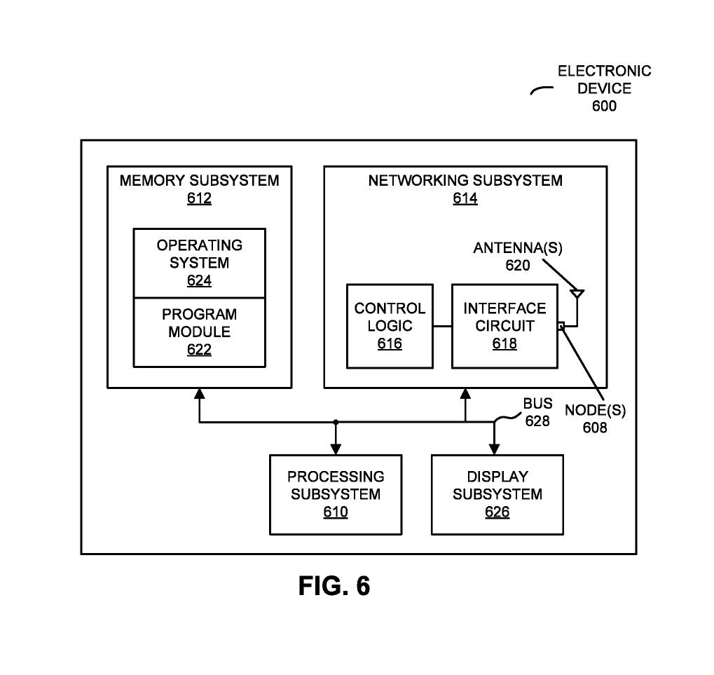

We now describe embodiments of an electronic device, such as an electronic device that performs the operations in FIG. 2 e.g., access point 112 (FIGS. 1, 3-5). FIG. 6 presents a block diagram illustrating an electronic device 600 in accordance with some embodiments. This electronic device includes processing subsystem 610, memory subsystem 612, and networking subsystem 614. Processing subsystem 610 includes one or more devices configured to perform computational operations. For example, processing subsystem 610 can include one or more microprocessors, application-specific integrated circuits (ASICs), microcontrollers, programmable-logic devices, and/or one or more digital signal processors (DSPs).

Memory subsystem 612 includes one or more devices for storing data and/or instructions for processing subsystem 610 and networking subsystem 614. For example, memory subsystem 612 can include dynamic random access memory (DRAM), static random access memory (SRAM), and/or other types of memory. In some embodiments, instructions for processing subsystem 610 in memory subsystem 612 include: one or more program modules or sets of instructions (such as program module 622 or operating system 624), which may be executed by processing subsystem 610. Note that the one or more computer programs may constitute a computer-program mechanism. Moreover, instructions in the various modules in memory subsystem 612 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 610.

In addition, memory subsystem 612 can include mechanisms for controlling access to the memory. In some embodiments, memory subsystem 612 includes a memory hierarchy that comprises one or more caches coupled to a memory in electronic device 600. In some of these embodiments, one or more of the caches is located in processing subsystem 610.

In some embodiments, memory subsystem 612 is coupled to one or more high-capacity mass-storage devices (not shown). For example, memory subsystem 612 can be coupled to a magnetic or optical drive, a solid-state drive, or another type of mass-storage device. In these embodiments, memory subsystem 612 can be used by electronic device 600 as fast-access storage for often-used data, while the mass-storage device is used to store less frequently used data.

Networking subsystem 614 includes one or more devices configured to couple to and communicate on a wired and/or wireless network (i.e., to perform network operations), including: control logic 616, an interface circuit 618 and one or more antennas 620 (or antenna elements). (While FIG. 6 includes one or more antennas 620, in some embodiments electronic device 600 includes one or more nodes, such as nodes 608, e.g., a pad, which can be coupled to the one or more antennas 620. Thus, electronic device 600 may or may not include the one or more antennas 620.) For example, networking subsystem 614 can include a Bluetooth™ networking system, a cellular networking system (e.g., a 3G/4G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 614 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 600 may use the mechanisms in networking subsystem 614 for performing simple wireless communication between the electronic devices, e.g., transmitting advertising or beacon frames and/or scanning for advertising frames transmitted by other electronic devices as described previously.

Within electronic device 600, processing subsystem 610, memory subsystem 612, and networking subsystem 614 are coupled together using bus 628. Bus 628 may include an electrical, optical, and/or electro-optical connection that the subsystems can use to communicate commands and data among one another. Although only one bus 628 is shown for clarity, different embodiments can include a different number or configuration of electrical, optical, and/or electro-optical connections among the subsystems.

In some embodiments, electronic device 600 includes a display subsystem 626 for displaying information on a display, which may include a display driver and the display, such as a liquid-crystal display, a multi-touch touchscreen, etc.

Electronic device 600 can be (or can be included in) any electronic device with at least one network interface. For example, electronic device 600 can be (or can be included in): a desktop computer, a laptop computer, a subnotebook/netbook, a server, a tablet computer, a smartphone, a cellular telephone, a consumer-electronic device, a portable computing device, an access point, a transceiver, a router, a switch, communication equipment, test equipment, and/or another electronic device.

Although specific components are used to describe electronic device 600, in alternative embodiments, different components and/or subsystems may be present in electronic device 600. For example, electronic device 600 may include one or more additional processing subsystems 610, memory subsystems 612, networking subsystems 614, and/or display subsystems 626. Additionally, one or more of the subsystems may not be present in electronic device 600. Moreover, in some embodiments, electronic device 600 may include one or more additional subsystems that are not shown in FIG. 6. Also, although separate subsystems are shown in FIG. 6, in some embodiments some or all of a given subsystem or component can be integrated into one or more of the other subsystems or component(s) in electronic device 600. For example, in some embodiments program module 622 is included in operating system 624 and/or control logic 616 is included in interface circuit 618.

Moreover, the circuits and components in electronic device 600 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 614. The integrated circuit may include hardware and/or software mechanisms that are used for transmitting wireless signals from electronic device 600 and receiving signals at electronic device 600 from other electronic devices. Aside from the mechanisms herein described, radios are generally known in the art and hence are not described in detail. In general, networking subsystem 614 and/or the integrated circuit can include any number of radios. Note that the radios in multiple-radio embodiments function in a similar way to the described single-radio embodiments.

In some embodiments, networking subsystem 614 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of cellular-telephone communication protocols and, more generally, wireless communication techniques may be used. Thus, the communication technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication technique may be implemented using program module 622, operating system 624 (such as a driver for interface circuit 618) or in firmware in interface circuit 618. Alternatively or additionally, at least some of the operations in the communication technique may be implemented in a physical layer, such as hardware in interface circuit 618.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
a node configured to couple to an antenna; and
an interface circuit, coupled to the node, configured to communicate with another electronic device using a wireless local area network (WLAN) communication protocol and an Evolved Packet Core (EPC) via a wired communication protocol, wherein the electronic device is configured to:
receive, at the interface circuit, Extensible Authentication Protocol (EAP) information using the WLAN communication protocol, wherein the EAP information includes credentials for authenticating the other electronic device to the EPC;
establish, via the interface circuit, one or more Internet Protocol Security (IPSec) tunnels associated with the EPC on behalf of the other electronic device using the wired communication protocol, wherein the one or more IPSec tunnels originate and terminate at the electronic device; and
communicate, via the interface circuit, encrypted information associated with the other electronic device using the WLAN communication protocol, wherein the encrypted information is encrypted using a different encryption protocol than IPSec.

2. The electronic device of claim 1, wherein the WLAN communication protocol comprises Wi-Fi.

3. The electronic device of claim 1, wherein the electronic device comprises a network function other than an access point.

4. The electronic device of claim 1, wherein the electronic device comprises a router.

5. The electronic device of claim 1, wherein the electronic device is configured to advertise, via the interface circuit, information for the other electronic device that indicates a capability to establish the one or more IPSec tunnels.

6. The electronic device of claim 1, wherein, prior to receiving the EAP information, the electronic device is configured to associate, via the interface circuit and using the WLAN communication protocol, with the other electronic device.

7. The electronic device of claim 1, wherein the encrypted information excludes a second encryption technique associated with the one or more IPSec tunnels.

8. The electronic device of claim 1, wherein, when communicating, via the interface circuit, a packet associated with the EPC using the one or more IPSec tunnels, the electronic device is configured to include an access point name (APN) in the packet.

9. The electronic device of claim 1, wherein the electronic device is configured to receive, via the interface circuit, a set of APNs associated with the electronic device and associated with different types of information; and
wherein, when communicating, via the interface circuit, a packet having a type of information that is associated with the EPC using the one or more IPSec tunnels, the electronic device is configured to select an APN associated with the type of information and to include the APN in the packet.

10. The electronic device of claim 1, wherein the encrypted information comprises Dynamic Host Configuration Protocol (DHCP) information associated with the EPC.

11. The electronic device of claim 1, wherein the credentials in the EAP information are encrypted.

12. The electronic device of claim 1, wherein the electronic device further comprises:
a processor; and
a memory, coupled to the processor, which stores a program module, wherein, when executed by the processor, the program module causes the electronic device to perform at least one of: the receiving, the establishing, and the communicating.

13. A non-transitory computer-readable storage medium for use in conjunction with an electronic device, the computer-readable storage medium storing a program module, wherein, when executed by the electronic device, the program module causes the electronic device establish one or more Internet Protocol Security (IPSec) tunnels with an Evolved Packet Core (EPC) for another electronic device by performing one or more operations, comprising:
receiving, at an interface circuit in the electronic device, Extensible Authentication Protocol (EAP) information using a wireless local area network (WLAN) communication protocol, wherein the EAP information includes credentials for authenticating the other electronic device to the EPC;
establishing, via the interface circuit, the one or more Internet Protocol Security (IPSec) tunnels associated with the EPC on behalf of the other electronic device using a wired communication protocol, wherein the one or more IPSec tunnels originate and terminate at the electronic device; and
communicating, via the interface circuit, encrypted information associated with the other electronic device using the WLAN communication protocol, wherein the encrypted information is encrypted using a different encryption protocol than IPSec.

14. The computer-readable storage medium of claim 13, wherein the electronic device comprises a network function other than an access point.

15. The computer-readable storage medium of claim 13, wherein the one or more operations comprise advertising, via the interface circuit, information for the other electronic device that indicates a capability to establish the one or more IPSec tunnels.

16. The computer-readable storage medium of claim 13, wherein, prior to receiving the EAP information, the one or more operations comprise associate, via the interface circuit and using the WLAN communication protocol, with the other electronic device.

17. The computer-readable storage medium of claim 13, wherein the encrypted information excludes a second encryption technique associated with the one or more IPSec tunnels.

18. The computer-readable storage medium of claim 13, wherein, when communicating, via the interface circuit, a packet associated with the EPC using the one or more IPSec tunnels, the one or more operations comprise including an access point name (APN) in the packet.

19. A method for establishing one or more Internet Protocol Security (IPSec) tunnels with an Evolved Packet Core (EPC) for another electronic device, comprising:
by an electronic device:
receiving, at the electronic device, Extensible Authentication Protocol (EAP) information using a wireless local area network (WLAN) communication protocol, wherein the EAP information includes credentials for authenticating the other electronic device to the EPC;
establishing the one or more Internet Protocol Security (IPSec) tunnels associated with the EPC on behalf of the other electronic device using a wired communication protocol, wherein the one or more IPSec tunnels originate and terminate at the electronic device; and
communicating encrypted information associated with the other electronic device using the WLAN communication protocol, wherein the encrypted information is encrypted using a different encryption protocol than IPSec.

20. The method of claim 19, wherein, when communicating a packet associated with the EPC using the one or more IPSec tunnels, the method comprises including an access point name (APN) in the packet.
